(19) United States
(12) Patent Application Publication
(10) Pub. No.: US 2009/0005243 A1
(43) Pub. Date: Jan. 1, 2009

(54) Doped metal organic frameworks for reversible H2 storage at ambient temperature

(76) Inventors: William A. Goddard, Pasadena, CA (US); Sang Soo Han, Pasadena, CA (US)

Correspondence Address: CHRISTIE, PARKER & HALE, LLP, PO BOX 7068, PASADENA, CA, 91109-7068, US

(21) Appl. No.: 12/150,046

(22) Filed: Apr. 23, 2008

Related U.S. Application Data
(60) Provisional application No. 60/925,917, filed on Apr. 23, 2007.

(51) Int. Cl. B01J 20/22

(52) U.S. Cl. 502/401

(57) ABSTRACT

Metal-organic frameworks (MOFs) are provided. An exemplary MOF includes a plurality of metal clusters, at least one linking ligand, and at least one dopant. Doped MOFs according to embodiments of the present invention have significantly increased H2 uptake capacity, and some embodiments meet the 2010 DOE H2 storage target of 6 wt % at a temperature ranging from −30 to 80° C. and a pressure less than or equal to 100 bar.

### CROSS-REFERENCE TO RELATED APPLICATION(S)

This application claims priority to and the benefit of U.S. Provisional Application Ser. No. 60/925,917, filed on Apr. 23, 2008 and titled LITHIUM-DOPED METAL ORGANIC FRAMEWORKS FOR REVERSIBLE H₂ STORAGE AT AMBIENT TEMPERATURE, the entire content of which is incorporated herein by reference.

### BACKGROUND OF THE INVENTION

Due to the dependence on foreign oil and emission of greenhouse gases associated with the use of fossil fuels for energy, recent research has been focused on the development of alternative fuel sources. Since a majority of fossil fuel resources are used for transportation applications, the bulk of the research has been focused on the development of alternative fuel sources suitable for use in automobiles and other vehicles. Among the most promising of these alternative fuels is hydrogen. However, the application of hydrogen as a fuel source is limited by problems associated with hydrogen storage. For use in transportation applications, the United States Department of Energy has set a number of goals for hydrogen storage systems. For example, a hydrogen powered vehicle needs 5 to 13 kg of on-board hydrogen storage to enable a driving range of greater than 300 miles before refueling. To achieve these goals, the Department of Energy has set a target gravimetric capacity of 6.0 wt % H₂ near room temperature.

Although hydrogen may be stored in either liquid or gas form, these storage options are not ideal. In particular, storage of liquid hydrogen requires storage at cryogenic temperatures, and storage of gaseous hydrogen requires storage at high pressures. As such, recent research has been focused on alternative methods of hydrogen storage. To that end, major advances have been made in materials-based storage of hydrogen.

Adsorption is one mechanism for hydrogen storage that is being extensively researched. Two major adsorption strategies for hydrogen storage in fuel cells are dissociative adsorption (chemisorption) and associative adsorption (physisorption). Dissociative adsorption generally involves the use of metal alloys that break the H—H bond and dissolve the H atoms separately in the matrix. However, these systems suffer from large barriers in breaking the H—H bond to chemisorb the H₂, and large barriers in re-associating the H atoms to desorb the H₂ for input into the fuel cell. In contrast, associative adsorption involves binding the H₂ as a molecule, eliminating the problems of adsorbing and desorbing associated with dissociative adsorption. However, the challenge in associative adsorption systems is in obtaining a sufficiently strong bond to molecular H₂ to achieve the Department of Energy target of 6.0 wt % H₂ near room temperature.

A major recent advance in associative adsorption systems is the development of metal-organic frameworks (MOFs), i.e. synthetic, crystalline, microporous materials composed of metal-oxide groups linked together by organic units. Due to their porosity, these materials have large surface areas, enabling the easy uptake and release of larger volumes of hydrogen. For example, at 60 bar and 77K, IRMOF-1 stores 5.0 wt % H₂ and MOF-177 stores 7.5 wt % H₂. However, the H₂ uptake capability of these MOFs dramatically decreases near room temperature to about 0.5 wt %, far too low for practical use. Although the H₂ storage capability at room temperature can be increased to 1.8 wt % at 298K and 100 bar by hydrogen spillover techniques, the current materials fall far short of the 2010 Department of Energy criteria for use in transportation, i.e. 6.0 wt % at a temperature ranging from −30 to 80° C.

### SUMMARY OF THE INVENTION

According to embodiments of the present invention, a doped metal-organic framework (MOF) includes a plurality of metal clusters, at least one linking ligand, and at least one dopant. In one embodiment, the metal cluster may be represented by MₘXₙ, in which M is a metal ion, X is a non-metal atom from Group 14 through Group 17, m is an integer from 1 to 10, and n is a number selected to charge balance the cluster in order to have the desired charge.

The multi-dentate linking ligand may be a charged linking ligand, and may include at least one anionic functional group such as a carboxylate (CO₂⁻), sulfate (SO₃⁻), or the like. In some embodiments, the multi-dentate linking ligand may be a bidentate or tridentate ligand. The multi-dentate ligand may have up to 60 atoms incorporated in aromatic or non-aromatic rings.

The dopant may be any suitable electropositive dopant. In one embodiment, for example, the dopant is selected from electropositive dopants from Groups 1 through 13, lanthanides and actinides. In some embodiments, the dopant is an alkali dopant, such as Li.

In some embodiments, the MOFs may further include at least one guest species. The guest species may be an adsorbed chemical species. Nonlimiting examples of these guest species include ammonia, carbon dioxide, carbon monoxide, hydrogen, amines, methane, oxygen, argon, nitrogen, organic dyes, polycyclic organic molecules, and combinations thereof. These guest species are introduced into the MOF by contacting the framework with the guest species. The ability of the MOFs to adsorb guest species makes them particularly suitable for H₂ uptake.

### BRIEF DESCRIPTION OF THE DRAWINGS

The patent or application file contains at least one drawing executed in color. Copies of this patent or patent application publication with color drawings will be provided by the Office upon request and payment of the necessary fee.

These and other features and advantages of the present invention will be better understood by reference to the following detailed description when considered in conjunction with the attached drawings in which:

FIG. 1a is a three-dimensional representation of a metal cluster according to one embodiment of the present invention;

FIG. 1b is a three-dimensional representation of a linking ligand having six aromatic carbon atoms according to one embodiment of the present invention;

FIG. 1c is a three-dimensional representation of a linking ligand having ten aromatic carbon atoms according to one embodiment of the present invention;

FIG. 1d is a three-dimensional representation of a linking ligand having sixteen aromatic carbon atoms according to one embodiment of the present invention;

FIG. 1e is a three-dimensional representation of a linking ligand having twenty-two aromatic carbon atoms according to one embodiment of the present invention;

FIG. 1f is a three-dimensional representation of a linking ligand having thirty aromatic carbon atoms according to one embodiment of the present invention;

FIG. 2 is a graph comparing the gravimetric uptake of H₂ at 300K and various pressures of doped MOFs according to embodiments of the present invention and undoped MOFs;

FIG. 3a is a graph comparing the gravimetric uptake of H₂ at various pressures and temperatures of doped MOFs according to embodiments of the present invention and undoped MOFs;

FIG. 3b is a graph comparing the volumetric uptake of H₂ at various pressures and temperatures of doped MOFs according to embodiments of the present invention and undoped MOFs;

FIG. 4 is a graph comparing the gravimetric uptake of H₂ at 300K at 100 bar pressure as a function of BET surface area of doped MOFs according to embodiments of the present invention and undoped MOFs;

FIG. 5a is a three-dimensional representation of a doped MOF according to one embodiment of the present invention;

FIG. 5b is a graph of the gravimetric H₂ uptake at 300K and various pressures of the doped MOF depicted in FIG. 5a;

FIG. 6 is a graph comparing the quantum calculations and fitted force fields for H₂ interacting with C₆H₆ in a MOF according to one embodiment of the present invention;

FIG. 7 is a graph of the Connelly surface area and BET surface area of pure, undoped MOFs;

FIG. 8 is a graph comparing the predicted and experimental H₂ adsorption isotherms of Zn-MOF-C6 at 77 K;

FIG. 9 is a graph of the predicted excess gravimetric H₂ uptake of Li-doped MOFs at 273K;

FIG. 10 is a graph of the predicted excess volumetric H₂ uptake of Li-doped MOFs at 273 K; and

FIG. 11 is a depiction of the distribution of adsorbed H₂ in a doped MOF according to one embodiment of the present invention.

### DETAILED DESCRIPTION OF THE INVENTION

Embodiments of the present invention are directed to doped metal-organic frameworks (MOFs). The MOFs are formed by a combination of metal cations and polydentate organic linkers. In one embodiment of the present invention, a MOF includes a plurality of metal clusters, at least one multidentate linking ligand, and at least one dopant. As used herein, “linking ligands” are chemical species (including neutral molecules and ions) that coordinate to two or more metals resulting in an increase in their separation and the definition of void regions or channels in the resulting framework. The linking ligands are described in more detail below, but some nonlimiting examples of suitable linking ligands include 4,4′-bipyridine (a neutral, multiple N-donor molecule) and benzene-1,4-dicarboxylate (a polycarboxylate anion).

Each metal of the plurality of metal clusters includes one or more metal ions, and the metal cluster may further include one or more non-linking ligands. As used herein, “non-linking ligands” are chemical species that coordinate to a metal but do not act as linkers. Non-linking ligands may bridge metals, but this typically occurs through a single coordinating functionality and therefore does not lead to a large separation. Nonlimiting examples of suitable non-linking ligands include water, hydroxide, halides, and coordinating solvents such as alcohols, formamides, ethers, nitrites, dimethylsulfoxide, and amines. Some specific, nonlimiting examples of suitable non-linking ligands include O²⁻, sulfate, nitrate, nitrite, sulfite, bisulfite, phosphate, hydrogen phosphate, dihydrogen phosphate, diphosphate, triphosphate, phosphite, chloride, chlorate, bromide, bromate, iodide, iodate, carbonate, bicarbonate, sulfides, hydrogen sulphate, selenide, selenate, hydrogen selenate, telluride, tellurate, hydrogen tellurate, nitride, phosphide, arsenide, arsenate, hydrogen arsenate, dihydrogen arsenate, antimonide, antimonate, hydrogen antimonate, dihydrogen antimonate, fluoride, boride, borate, hydrogen borate, perchlorate, chlorite, hypochlorite, perbromate, bromite, hypobromite, periodate, iodite, hypoiodite, and mixtures thereof.

As noted above, the MOFs include metal clusters and at least one multi-dentate linking ligand. Each ligand of the multidentate linking ligands connects adjacent metal clusters. Typically, the multidentate linking ligands have a sufficient number of accessible sites for atomic or molecular adsorption that the surface area per gram of material is greater than 2,900 m2/g. Specifically, the multidentate ligand has a sufficient number of edges available for atomic or molecular adsorption that the surface area per gram of material is greater than 2,900 m2/g. “Edges” are regions within the pore volume in proximity to a chemical bond (single-, double-, triple-, aromatic-, or coordination-) where sorption of a guest species may occur. Nonlimiting examples of edges include regions near exposed atom-to-atom bonds in an aromatic or non-aromatic group, where “exposed” means that the bond does not occur at the position where rings are fused together. As used herein, “guests” are any chemical species that reside within the void regions of an open framework solid that are not considered integral to the framework. Nonlimiting examples of guests include molecules of the solvent that fill the void regions during synthesis, other molecules that are exchanged for the solvent such as during immersion (via diffusion) or after evacuation of the solvent molecules, e.g. gases.

In some embodiments of the present invention, the plurality of multidentate ligands has a sufficient number of accessible sites (i.e., edges) for atomic or molecular adsorption that the surface area per gram of material is greater than 3,000 m²/g. In other embodiments, the plurality of multidentate ligands has a sufficient number of accessible sites for atomic or molecular adsorption that the surface area per gram of material is greater than 3,500 m²/g. In still other embodiments, the plurality of multidentate ligands has a sufficient number of accessible sites for atomic or molecular adsorption that the surface area per gram of material is greater than 4,000 m²/g.

In one embodiment, the metal cluster may be represented by MₘXₙ, in which M is a metal ion, X is an anion of a non-metal atom from Group 14 through Group 17, m is an integer from 1 to 10, and n is a number selected to charge balance the cluster in order to have the desired charge. The metal ions may include one or more ions selected from Group 1 through Group 16 metals including actinides and lanthanides. Nonlimiting examples of suitable metal ions for use in the metal clusters according to embodiments of the present invention include Li⁺, Na⁺, K⁺, Rb⁺, Be⁺, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²+, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²+, Cd²⁺, Hg²⁺, Al³⁺, Ga³⁺, In³⁺, Tl³⁺, Si⁴⁺, Si²⁺, Si²⁺, Ge⁴+, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺, and combinations thereof. In some embodiments, for example, M is selected from Mg²⁺, Ca²⁺, Sr²⁺, Ba²⁺, V²⁺, V³⁺, V⁴⁺, V⁵⁺, Mn²⁺, Re²⁺, Fe²⁺, Fe³⁺, Ru³⁺, Ru²⁺, Os²⁺, Co²⁺, Rh²⁺, Rh²⁺, Ir²⁺, Ni²⁺, Pd²⁺, Pt²⁺, Cu²⁺, Zn²⁺, Cd²⁺, Hg²⁺, Si²⁺, Ge²⁺, Sn²⁺ and Pb²⁺. In other exemplary embodiments, Co²⁺, Cu²⁺ and Zn²⁺ are used as the metal ion. Nonlimiting examples of suitable materials for X include anions of O, N and S. One nonlimiting example of a metal cluster satisfying these criteria is Zn4O (in which M is Zn, X is O, m is 4 and n is 1).

The metal clusters of the MOFs are linked by at least one multidentate linking ligand. The multi-dentate linking ligand may be a charged linking ligand, which may include an anionic functional group such as carboxylates (CO₂⁻), sulfates (SO₃⁻), and the like. Each of the multi-dentate linking ligands may include two or more charged functional groups. In some embodiments, the multi-dentate linking ligand may be a bidentate or tridentate ligand, but the present invention is not limited thereto, and contemplates higher numbers of functional groups. In one embodiment, for example, a suitable multi-dentate ligand may include 2, 3 or more functional groups, e.g. carboxylate groups. The multi-dentate ligand may have more than 16 atoms incorporated in aromatic rings or non-aromatic rings. In other embodiments, the multi-dentate ligand has more than 20 atoms incorporated in aromatic or non-aromatic rings. In some embodiments, the multi-dentate ligand may have up to 60 atoms incorporated in aromatic or non-aromatic rings.

Alternatively, the multi-dentate ligand may have at least 16 edges contained in the aromatic or non-aromatic rings. In some embodiment, the multi-dentate ligand has at least 18 edges n the aromatic or non-aromatic rings. In still other embodiments, the multi-dentate ligand has at least 24 edges in the aromatic or non-aromatic rings. In some embodiments, for example, the multi-dentate ligand may have up to 60 edges in the aromatic or non-aromatic rings. In one embodiment, the multi-dentate ligand may be a substituted or unsubstituted ligand represented by Formula 1, below.

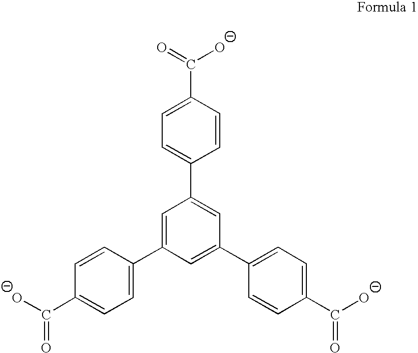

Substituted variations of the ligands represented by Formula 1 may include ligands in which the hydrogen atoms on the rings are substituted with substituents such as alkyl groups, alkoxy groups, halogens, nitro groups, cyano groups, aryl groups, aralkyl groups, and the like. Nonlimiting examples of ligands satisfying these criteria include Zn₄O(BTB)₃(DEF)ₓ, where BTB is the unsubstituted material of Formula 1, DEF is N,N-diethylformamide, and x represents the number of coordinated N,N-diethylformamide molecules. In some embodiments, x may range from 0 to 25.

In another embodiment, the multi-dentate ligand may be a substituted or unsubstituted ligand represented by Formula 2, below.

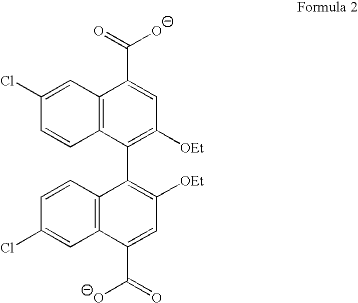

Substituted variations of the ligands represented by Formula 2 may include ligands in which the hydrogen atoms on the rings are substituted with substituents such as alkyl groups, alkoxy groups, halogens, nitro groups, cyano groups, aryl groups, aralkyl groups, and the like. Nonlimiting examples of ligands satisfying these criteria include those represented by Zn₄O(DCPB)₃(DEF)ₓ, where DCPB is the unsubstituted material of Formula 2, DEF is N,N-diethylformamide, and x represents the number of coordinated N,N-diethylformamide molecules. In one embodiment, x may range from 0 to 25.

Other nonlimiting examples of suitable multi-dentate ligands include those represented by Formulae 3 through 21, below.

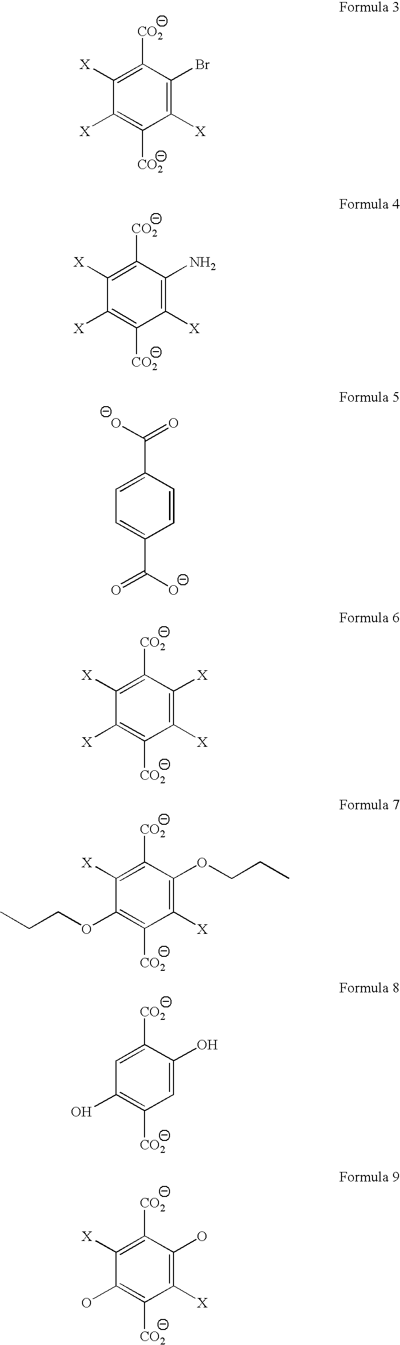

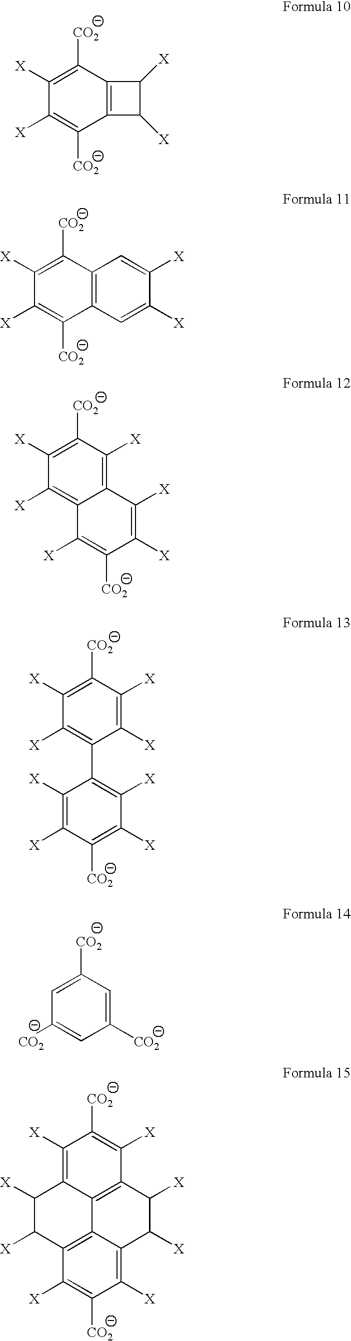

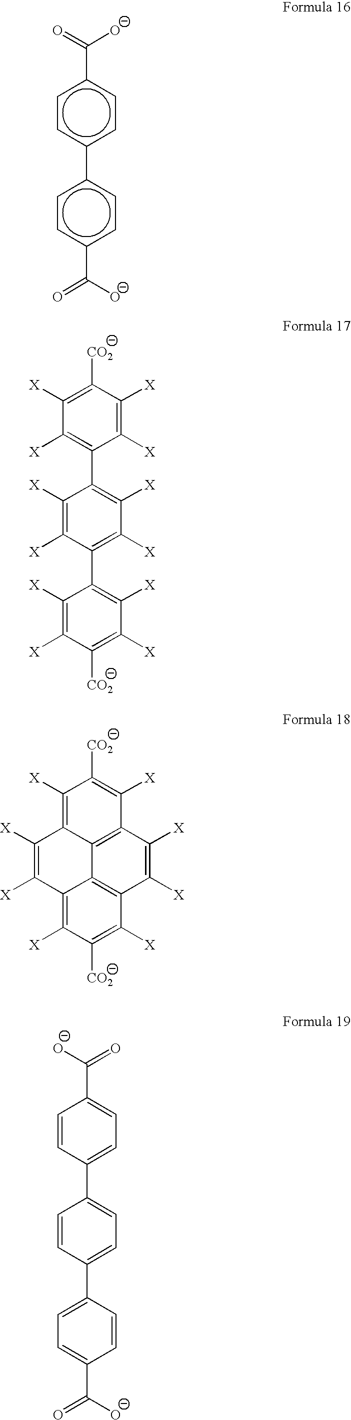

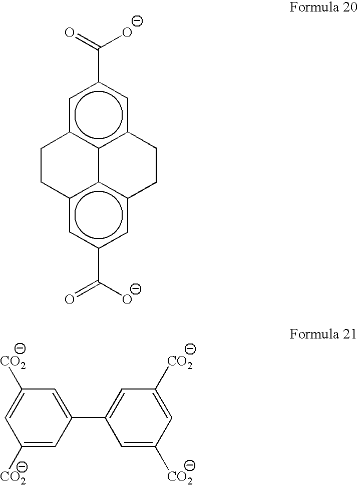

In Formulae 3 through 21, M is a metal atom, R is a C1-10 alkyl, and X may be any suitable functional group. For example, x may be selected from hydrogen, —NHR, —N(R)₂, halides, C1-10 alkyls, C6-18 aryls, C6-18 aralkyls, —NH₂, alkenyls, alkynyls, —Oalkyl, —NH(aryl), cycloalkyls, cycloalkenyls, cycloalkynyls, —(CO)R, —(S₂)R, —(CO₂)R, —SH, —S(alkyl), —SO₃H, —SO³⁻M⁺, —COOH, —COO⁻M⁺, —PO₃H₂, —PO₃H⁻M⁺, —PO₃²⁻M²⁺, —NO₂, —CO₂H, silyl derivatives, borane derivatives, ferrocenes and other metallocenes.

In other embodiments of the present invention, the multi-dentate ligand may be a substituted or unsubstituted ligand represented by Formula 22, below.

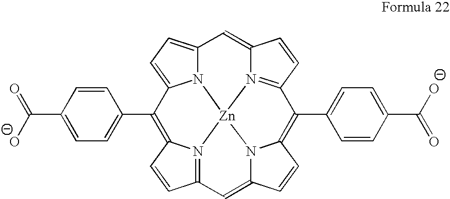

Substituted variations of the ligands represented by Formula 22 may include ligands in which the hydrogen atoms on the rings are substituted with substituents such as alkyl groups, alkoxy groups, halogens, nitro groups, cyano groups, aryl groups, aralkyl groups, and the like. One nonlimiting example of a ligand satisfying these criteria is Zn₄O(C₃₄H₁₂O₄N₄Zn)₃(DEF)ₓ (also expressed as ZnO[Zn(BCPP)]₃(DEF)ₓ), where BCPP is the unsubstituted ligand represented by Formula 22, DEF is N,N-diethylformamide, and x represents the number of coordinated N,N-diethylformamide molecules.

In some embodiments of the present invention, the MOFs are isoreticular in structure. Like the MOFs described above, the isoreticular MOFs also include a plurality of metal clusters, at least one multi-dentate linking ligand and at least one dopant. Nonlimiting examples of suitable multi-dentate linking ligands for use in isoreticular MOFs include substituted and unsubstituted variations of the ligands represented by Formulae 23 through 34, below.

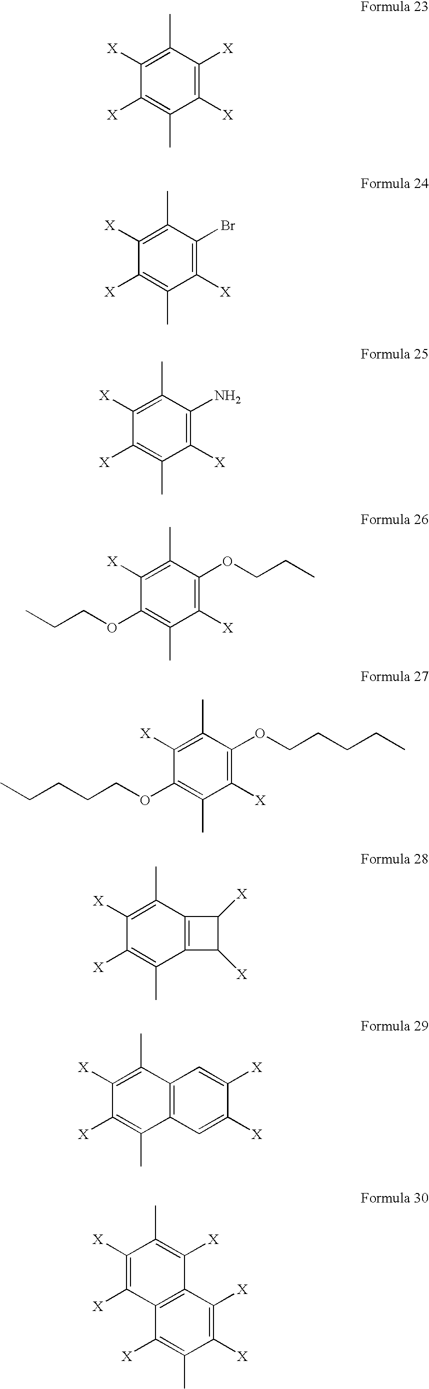

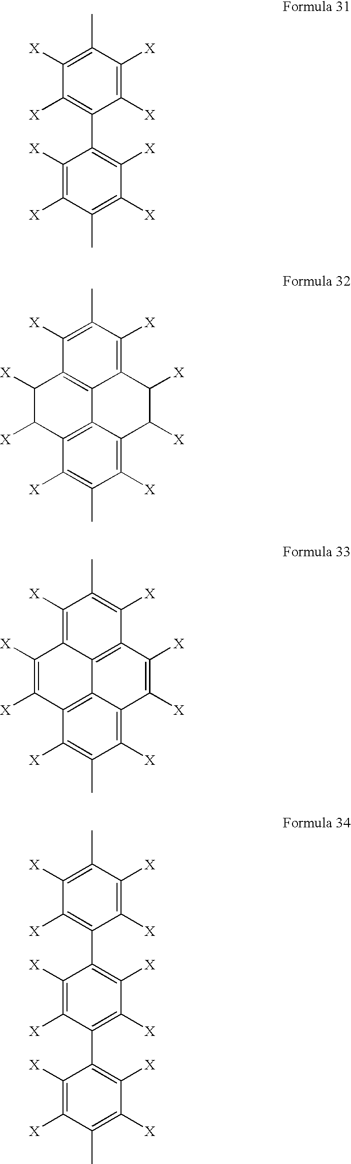

In Formulae 23 through 34, X may be any suitable functional group, nonlimiting examples of which include hydrogen, amines and halides. Other nonlimiting examples of suitable functional groups for X include linear, substituted, unsubstituted and cyclo alkanes, alkenes and alkynes. X may also be an ether represented by O—R, where R may be a linear, substituted, unsubstituted or cyclo alkane, alkene or alkyne. In particular, X may be selected from amines (including primary, secondary and tertiary amines), aromatic amines, pyridine, pyrimidine like five and six membered rings, halides including halogen substituted R groups (—RX), alcohols, thiols, sulfonates, nitro groups, phosphates, epoxides, alkanes, alkenes, alkynes, aldehydes, ketones, esters, carboxylic acids, cycloalkanes, cycloalkenes, cycloalkynes, silyl derivatives, borane derivatives, ferrocenes and other metallocenes.

According to other embodiments, the linking ligand may be any suitable linking ligand including at least one aromatic ring. Nonlimiting examples of suitable such linking ligands include those represented by Formulae 35 through 39 below.

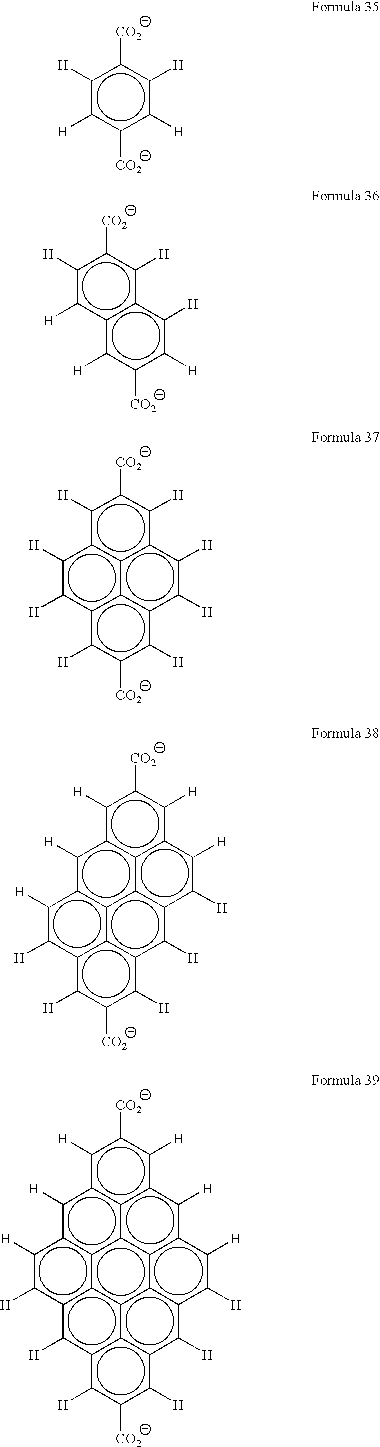

Any of the H atoms of the ligands of Formulae 35 through 39 may be substituted with a X group as defined above with respect to Formulae 1 through 34.

The MOFs further include at least one dopant. The dopant may be any suitable electropositive dopant. In one embodiment, for example, the dopant is selected from electropositive dopants from Groups 1 through 13, lanthanides and actinides. Specifically, nonlimiting examples of suitable dopants include Li, Na, K, Rb, Cs, Fr, Be, Mg, Ca, Sr, Ba, Ra, Sc, Y, La, Ac, Ti, Zr, Hf, Rf, V, Nb, Ta, Db, Cr, Mo, W, Sg, Mn, Tc, Re, Bh, Fe, Ru, Os, Hs, Co, Rh, Ir, Mt, Ni, Pd, Pt, Ds, Cu, Ag, Au, Rg, Zn, Cd, Hg, Al, Ga, In, Tl, Ce, Pr, Nd, Pm, Sm, Eu, Gd, Tb, Dy, Ho, Er; Tm, Yb, Lu, Th, Pa, U, Np, Pu, Am, Cm, Bk, Cf, Es, Fm, Md, No, and Lr. In one embodiment, for example, the dopant is selected from Li, Na, K, Rb and Cs. In another embodiment, the dopant is an alkali dopant, such as Li. In one embodiment, a ratio of aromatic carbon atoms to dopant atoms (e.g., lithium atoms) may range from about 4:1 to about 7:1. In one embodiment, for example, the ratio may range from about 5:1 to about 6:1. In addition, dopant may be present in the MOF in an amount ranging from about 2.5 to about 7.2 wt %. In one embodiment, for example, the dopant may be present in an amount ranging from about 2.63 wt % to about 7.01 wt %. Specifically, in some embodiments of the present invention, the dopant is present in an amount of 2.63 wt % for doped MOF-C6, 4.33 wt % for doped MOF-C10, 5.18 wt % for doped MOF-C16, 5.75 wt % for doped MOF-C22, and 7.01 wt % for doped MOF-C30.

In addition to a plurality of metal clusters, at least one linking ligand, and at least one dopant, the MOFs according to embodiments of the present invention may also include at least one guest species. As discussed above, “guests” are any chemical species that reside within the void regions of an open framework solid that are not considered integral to the framework. Nonlimiting examples of guests include molecules of the solvent that fill the void regions during synthesis, other molecules that are exchanged for the solvent such as during immersion (via diffusion) or after evacuation of the solvent molecules, e.g. gases.

The presence of a guest species can advantageously increase the surface area of the MOFs. Nonlimiting examples of guest species include organic molecules with a molecular weight less than 100 g/mol, organic molecules with a molecular weight less than about 300 g/inol, organic molecules with a molecular weight less than about 600 g/mol, organic molecules with a molecular weight greater than about 600 g/mol, organic molecules containing at least one aromatic ring, polycyclic aromatic hydrocarbons, and metal complexes represented by MmXn where M is a metal ion, X is selected from Group 14 through Group 17 anions, m is an integer from 1 to 10, and n is a number selected to charge balance the metal cluster to have a desired electric charge. The guest species may also include combinations of these materials. The guest species is introduced into the MOF by contacting the framework with the guest species.

In some embodiments, the guest species is an adsorbed chemical species. Nonlimiting examples of these guest species include ammonia, carbon dioxide, carbon monoxide, hydrogen, amines, methane, oxygen, argon, nitrogen, organic dyes, polycyclic organic molecules, and combinations thereof. These guest species are also introduced into the MOF by contacting the framework with the guest species.

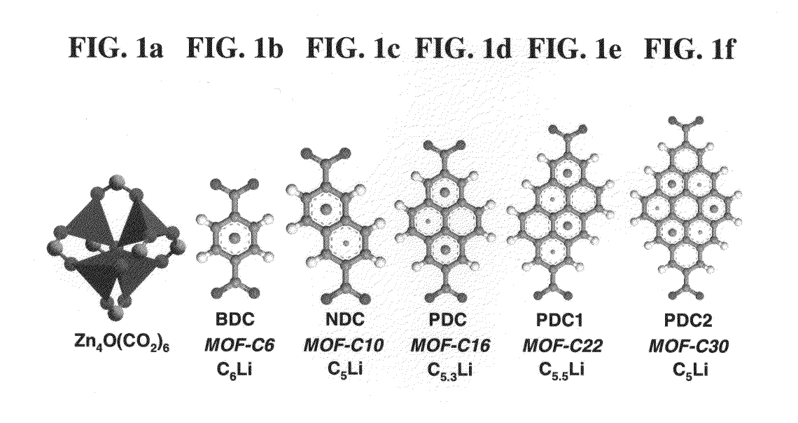

Nonlimiting examples of MOFs satisfying the above-described criteria include those with a Zn₄(CO₂)₆ metal cluster (shown in FIG. 1a) connected to six aromatic linking ligands through the O—C—O linkage common to each linking ligand. Exemplary MOFs include MOF-C6 (including a linking ligand with 6 aromatic carbon atoms, the linking ligand is shown in FIG. 1b), MOF-C10 (including a linking ligand with 10 aromatic carbon atoms, the linking ligand is shown in FIG. 1c), MOF-C16 (including a linking ligand with 16 aromatic carbon atoms, the linking ligand is shown in FIG. 1d), MOF-C22 (including a linking ligand with 22 aromatic carbon atoms, the linking ligand is shown in FIG. 1e) and MOF-C30 (including a linking ligand with 30 aromatic carbon atoms, the linking ligand is shown in FIG. 1f). In FIGS. 1b through 1f, the larger violet-colored atoms represent Li atoms lying above the linking ligands, and the smaller violet-colored atoms represent Li atoms that lie below the linking ligands. The MOFs prepared from the linking ligands depicted in FIGS. 1a through 1f have C to Li ratios (expressed as CₓLi) of C₆Li (MOF-C6), C₅Li (MOF-C10), C_{5.3}Li (MOF-C16), C_{5.5}Li (MOF-C22), and C₅Li (MOF-C30). The C to Li ratio considers only the aromatic carbon atoms. Each of the MOFs of Formulae 36 through 40 is based on a cubic lattice with lattice parameters of 26.025 Å for MOF-C6, 30.252 Å for MOF-C10, 34.374 Å for MOF-C15, 38.652 Å for MOF-C22, and 42.824 Å for MOF-C30.

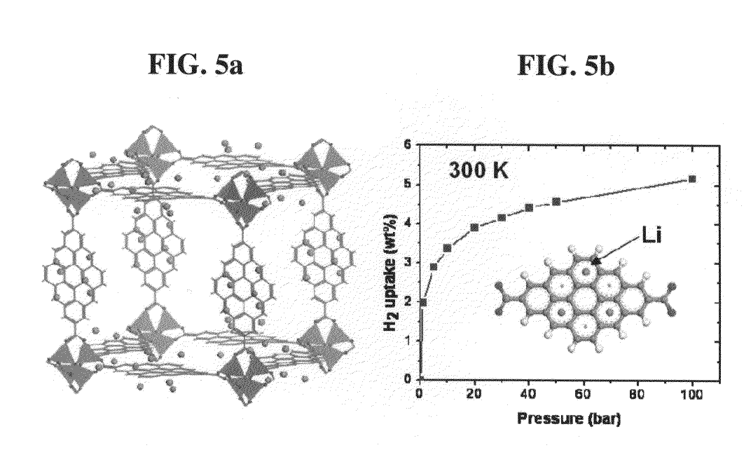

One exemplary MOF including the linking ligand depicted in FIG. 1f is depicted in FIG. 5a. As shown in FIG. 5a, the plurality of metal clusters are linked by the plurality of linking ligands, and the dopant (in this case, Li) lies above and below the centers of the aromatic rings of the linking ligands. FIG. 5b is a graph of the gravimetric H₂ uptake of this MOF at 300K and various pressures. As shown in FIG. 5b, the MOF depicted in FIG. 5a has a gravimetric H₂ uptake at 300K and 100 bar pressure of over 5 wt %.

### Analysis of Exemplary Doped MOFs

Quantum mechanics (QM) calculations (X3LYP flavor of DFT) were used to predict the structure for Li atoms bound to aromatic organic linking ligands with up to 9 fused rings. Based on these calculations, Li atoms apparently prefer to bind at the centers of the hexagonal aromatic rings. However, Li atoms on adjacent aromatic rings are on opposite sides. To predict the strength of binding H₂ to these structures, QM calculations (high-quality second order Møller-Plesset (MP2) at the quadruple zeta QZVPP and triple zeta TZVPP basis sets) were used to calculate the van der Waals interaction between H₂ and the metal oxide clusters, and between H₂ and the organic linking ligands.

QM calculations were used instead of DFT methods. DFT methods are well known to lead to poor descriptions of the London dispersion attractive terms dominating weakly bound van der Waals molecules, and therefore are not useful for predicting interaction energies between dihydrogen and the organics of MOFs. Therefore, all coupled clusters were optimized using second-order Møller-Plesset (MP2) calculations with the approximate resolution of the identity (RI-MP2). These calculations were carried out with the TURBOMOLE program.

For H₂ on benzene, the triple zeta valence basis (TZV) was used supplemented with polarization functions from the cc-pVTZ basis, which is denoted TZVPP (the 1 s electrons of the C and O atoms are not correlates, frozen-core approximation was used). The binding energy of H₂ with benzene was corrected for basis-set superposition error (BSSE) by the full counterpoise procedure. In addition, the appropriate auxiliary-TZVPP basis set was used for the RI-MP2 calculations.

In the case of H₂-MOF clusters, the geometries were optimized up to the RI-MP2/TZVPP theoretical level with frozen cores in each case. Then, single point energies were calculated using RI-MP2 with the quadruple zeta QZVPP basis. Here, BSSE corrections were not used, since this has been shown to be unnecessary for Zn-MOF clusters.

The QM calculated H—H bond length, 0.74 Å, is comparable to the experimental value of 0.75 Å for a free H₂ molecule. Moreover, the QM vibration frequency of H₂ was 4224 cm⁻¹, which is close to the experimental value of 4400 cm⁻¹ for free H₂. The H₂ binding energy with the Zn containing cluster was calculated to be −1.49 kcal/mol (Table 1 below), which is in good agreement with the reported value of −1.51 kcal/mol. Table 1 below lists the QM data (RI-MP2, energies in Hartree) and force field data (energies in kcal/mol) for the binding of an H₂ molecule to the metal oxide cluster and to the benzene ring.

TABLE 1

| | Zn cluster- H₂^{a} | Benzene- H₂^{b} |
|---|---|---|
| H₂ | −1.166651 | −1.164698 |
| M₄O(CO₂)₆H₆ | −8322.821264 | −231.733624 |
| M₄O(CO₂)₆H₆—H₂ | −8323.990283 | −232.899789 |
| Binding energy | −1.49 | −0.91 |
| Force field | −1.48 | −0.91 |

^{a}QZVPP basis set
^{b}TZVPP basis set

The QM calculations were then fitted to a force field (FF) describing the nonbond H—C, H—O, and H—Zn FF interactions. The final FF yielded structures and energies in good agreement with the QM data.

QM calculations were used to determine the interaction potential of H₂ with the metal sites and linking ligands of the MOFs. These results were then fitted to obtain Morse pair potentials (by Equation 1 below) between each atom of H with the MOF.

$${U}_{ij} ( {r}_{ij} ) = D \{ exp [ α ( 1 - \frac{{r}_{ij}}{{r}_{o}} ) ] - 2 \cdot exp [ \frac{α}{2} ( 1 - \frac{{r}_{ij}}{{r}_{o}} ) ] \} \qquad ( 1 )$$

In equation 1, D is the well depth, r₀ is the equilibrium bond distance, and α is the force constant (which determines the stiffness).

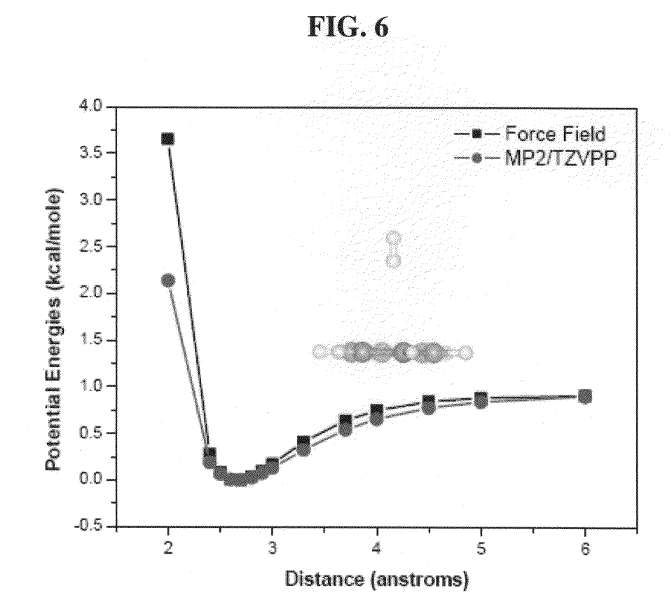

For the C—H cross term, RI-MP2/TZVPP calculations were carried out for the interaction between H₂ and C₆H₆ molecules as shown in FIG. 6. FIG. 6 is a comparison of the quantum calculations and fitted force fields for H₂ interacting with C₆H₆. In these calculations, the H₂ was oriented vertically to the C₆H₆ ring, and the distance between the bond midpoint of H₂ and the center of the benzene were varied.

For the interactions of H₂ with the metal site in the MOF, RI-MP2/QZVPP calculations were carried out for clusters such as Zn₄O(CO₂)₆H₆+H₂ and the results are listed in Table 1 above. The optimized structures are listed in Table 2 below, which lists the coordinates (Å) of Zn₄O(CO₂)₆H₆ and Zn₄O(CO₂)₆H₆-H₂ optimized by RI-MP2/TZVPP.

TABLE 2

| | | | | Zn- | | | |
|---|---|---|---|---|---|---|---|
| Zn- | | | | MOF- | | | |
| MOF | x | y | z | H₂ | x | y | z |
| O | 0.004 | −0.002 | 0.006 | O | 0.008 | 0.003 | 0.000 |
| Zn | 0.976 | 1.119 | −1.294 | Zn | 0.973 | 1.112 | −1.316 |
| Zn | 1.296 | −1.087 | 1.032 | Zn | 1.308 | −1.066 | 1.027 |
| Zn | −1.014 | 1.153 | 1.239 | Zn | −1.003 | 1.165 | 1.233 |
| Zn | −1.238 | −1.197 | −0.955 | Zn | −1.240 | −1.201 | −0.942 |
| O | 1.196 | −0.676 | 2.949 | O | 1.231 | −0.629 | 2.942 |
| O | 3.135 | −0.759 | 0.426 | O | 3.144 | −0.740 | 0.412 |
| O | 0.933 | −3.006 | 0.819 | O | 0.945 | −2.988 | 0.843 |
| O | −0.741 | 3.053 | 0.816 | O | −0.769 | 3.061 | 0.769 |
| O | −0.450 | 0.870 | 3.10 | O | −0.431 | 0.899 | 3.093 |
| O | −2.941 | 0.781 | 1.132 | O | −2.928 | 0.781 | 1.153 |
| O | −1.120 | −0.932 | −2.897 | O | −1.141 | −0.944 | −2.887 |
| O | −0.842 | −3.084 | −0.583 | O | −0.829 | −3.083 | −0.559 |
| O | −3.097 | −0.863 | −0.416 | O | −3.095 | −0.868 | −0.388 |
| O | 0.409 | 0.720 | −3.132 | O | 0.391 | 0.700 | −3.149 |
| O | 2.913 | 0.802 | −1.197 | O | 2.908 | 0.788 | −1.242 |
| O | 0.667 | 3.028 | −0.955 | O | 0.642 | 3.023 | −1.000 |
| C | 0.049 | −3.594 | 0.145 | C | 0.064 | −3.585 | 0.172 |
| C | −0.416 | −0.127 | −3.560 | C | −0.444 | −0.144 | −3.563 |
| C | −3.565 | −0.049 | 0.421 | C | −3.557 | −0.051 | 0.450 |
| C | −0.041 | 3.590 | −0.080 | C | −0.085 | 3.590 | −0.144 |
| C | 3.569 | 0.020 | −0.461 | C | 3.570 | 0.024 | −0.493 |
| C | 0.439 | 0.115 | 3.570 | C | 0.469 | 0.158 | 3.563 |
| H | 0.054 | −4.686 | 0.200 | H | 0.075 | −4.677 | 0.232 |
| H | −0.538 | −0.169 | −4.646 | H | −0.582 | −0.187 | −4.647 |
| H | −4.651 | −0.063 | 0.547 | H | −4.643 | −0.067 | 0.584 |
| H | −0.048 | 4.684 | −0.102 | H | −0.126 | 4.682 | −0.200 |
| H | 4.652 | 0.019 | −0.611 | H | 4.653 | 0.024 | −0.648 |
| H | 0.570 | 0.149 | 4.655 | H | 0.609 | 0.203 | 4.646 |
| | | | | H | 2.328 | 2.362 | 1.567 |
| | | | | H | 2.554 | 1.757 | 1.9245 |

To determine the interactions of H₂ with the Li bonded to an aromatic hydrocarbon, one H₂ bonded to a planar C₃₂ cluster (ten aromatic rings) doped with one Li atom on each side was calculated. These calculations used the X3LYP flavor of DFT with the 6-311G(d,p) basis set. Such DFT calculations are expected to yield an accurate description of van der Waals and hydrogen bond interactions.

The FFs developed from the QM calculations are summarized in Table 3 below. Table 3 lists the van der Waals force field parameters developed from QM data. In Table 3, H_ and H_A indicate hydrogen in a H₂ molecule and hydrogen bonded with an aromatic carbon ring (such as such as C₆H₆), respectively.

TABLE 3

| Term | D (kcal/mol) | r0 (Å) | α |
|---|---|---|---|
| C---H_A | 0.10082 | 3.12022 | 12.00625 |
| H_---H_A | 0.00087 | 3.24722 | 12.00625 |
| H_A---H_A^{a} | 0.01815 | 3.56980 | 10.70940 |
| O---H_A | 0.02515 | 3.32249 | 12.00187 |
| Zn---H_A | 0.12447 | 2.76130 | 13.41420 |
| Li---H_A | 2.15752 | 2.01844 | 7.12510 |

^{a}For H_A---H_A van der Waals term, the potential curves were fitted between two H₂ molecules using CCSD(T) with aug-cc-pVQZ basis set.

With this first principles derived FF, grand canonical ensemble Monte Carlo (GCMC) simulations were used to calculate the theoretical H₂ uptake behavior of the Li-doped MOFs. These simulations were performed for loadings of hydrogen molecules at various pressures and temperatures in MOFs according to embodiments of the present invention. To substantially eliminate boundary effects, an infinite three-dimensionally periodic cell containing four independent sheets (each with 32 Zn atoms) was used.

In the GCMC calculations, the structure of the Li-doped MOF system is fixed at the value determined by the FF. Then, the new force field defined in Table 3 was used to describe the van der Waals interactions of H₂ in the MOF systems. To obtain an accurate measure of H₂ loading, 10,000,000 configurations were constructed to compute the average loading for each condition. The sorbent model used a three-dimensional structure (2×2×2 supercell) including eight Zn₄O(CO₂)₆ cluster units, each of which was connected to 6 organic linking ligands.

In all simulations, periodic boundary conditions were applied in order to minimize undesirable surface effects. Generally, MOF structures can have both cubic and hexagonal crystals. Experimentally, a hexagonal Zn-MOF-177 has a larger surface area based on the higher N₂ uptake amount than a cubic MOF-12. However, the hexagonal structure leads to lower H₂ storage. Optimization of the cubic MOF systems may therefore be desired.

Table 4, below, lists the crystal sizes and surface areas of the MOFs analyzed. These crystal structures were minimized using the DREIDING force field. The predicted structures for Zn-MOF-C6, -C10 and -C16 are in good agreement with experimental data. Table 4 lists the lattice parameters (Å) and surface areas (m²/g) of MOFs used in this simulation, where all structures were assumed to have a cubic lattice (Fₘ₋₃ₘ space group).

TABLE 4

| | MOF6 | MOF10 | MOF16 | MOF22 | MOF30 |
|---|---|---|---|---|---|
| Lattice | 26.025 | 30.252 | 34.374 | 38.652 | 42.824 |
| parameter | (25.832)^{a} | (30.092)^{a} | (34.381)^{a} | | |
| Connolly | 3851^{c} | 3518^{c} | 3808^{c} | 4550^{c} | 4641^{c} |
| surface | (3834)^{d} | (3378)^{d} | (3528)^{d} | (3940)^{d} | (3938)^{d} |
| area^{b} | | | | | |
| H₂ BET | 1287^{c} | 1494^{c} | 1746^{c} | 1955^{c} | 2046^{c} |
| surface area^{e} | (395)^{d} | (693)^{d} | (920)^{d} | (1040)^{d} | (1138)^{d} |

^{a}Experimental results [Ref. 13]
^{b}The Connolly surface area was calculated by the Cerius2 software.
^{c}For pure Zn-MOFs
^{d}For Li-doped Zn-MOFs. Here we assumed that lattice parameters of Li-doped MOFs were same to those of pure MOFs.
^{e}The H₂ BET surface area was calculated from our H₂ adsorption isotherms at 300 K for Li-doped MOFs and at 77 K for pure MOFs.

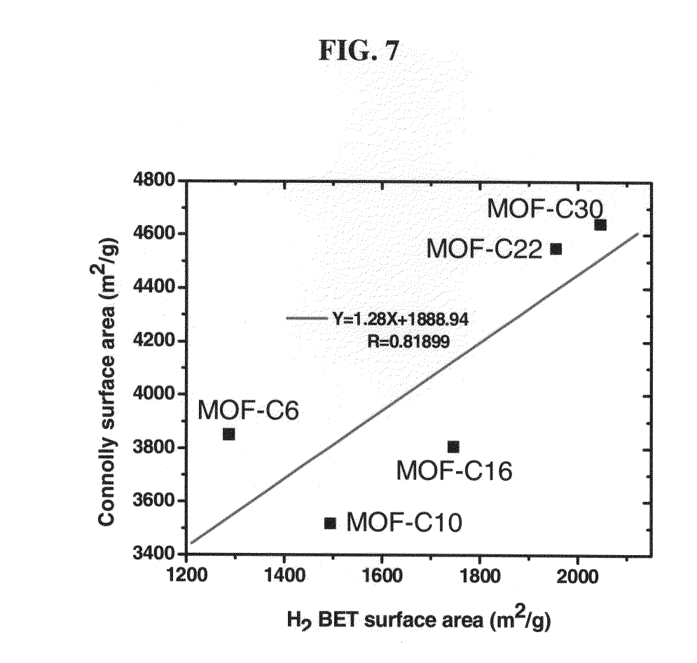

FIG. 7 shows the relationship between the Connolly surface area and the H₂BET surface area for pure, undoped MOFs. The BET surface area is about ⅓ the Connolly surface area, but the relationship is approximately linear.

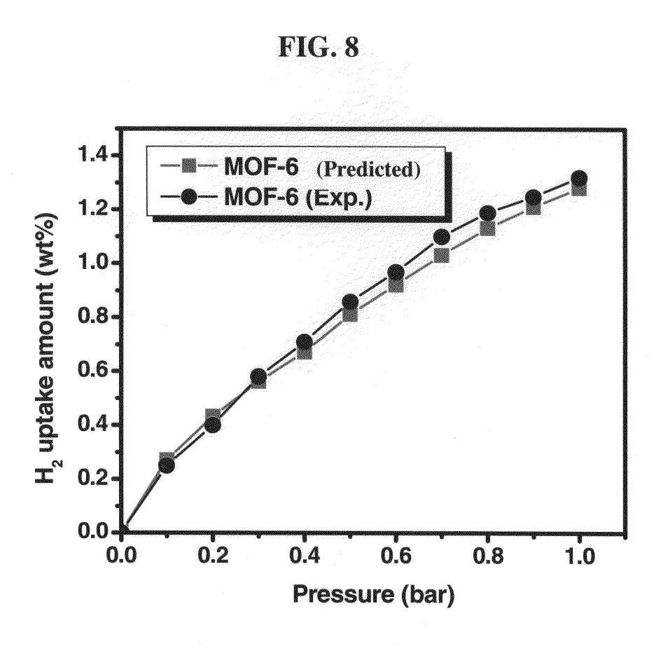

Using the optimized structures, H₂ adsorption isotherms were calculated at 77 and 100 K. For Zn-MOF-C6, the predicted H₂ adsorption isotherms compare well with experimental results, as shown in FIG. 8, which is a graph comparing the predicted and experimental isotherms for Zn-MOF-C6.

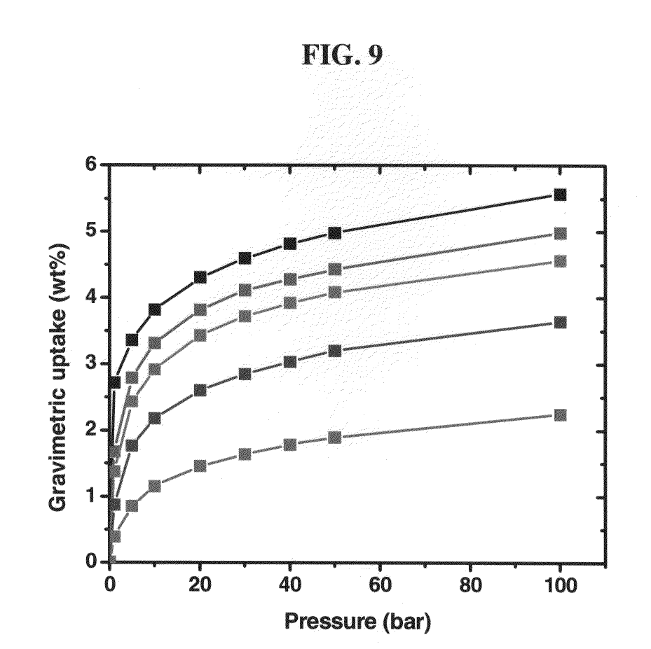

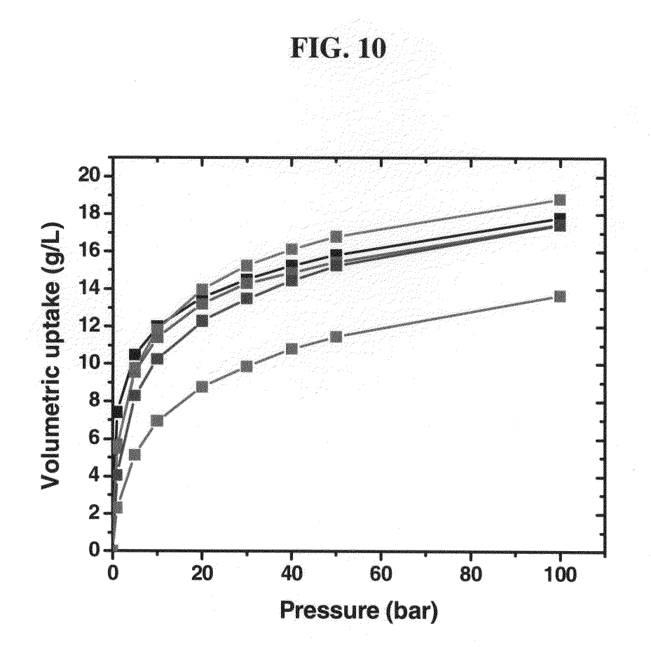

FIG. 9 is a graph of the H₂ adsorption isotherms in gravimetric units of Li-doped MOFs at 273 K and various pressures (<100 bar), and FIG. 10 is a graph of the H₂ adsorption iostherms in volumetric units of the Li-doped MOFs. In FIGS. 9 and 10, Li-doped MOF-C6 is depicted in cyan, Li-doped MOF-C10 is depicted in blue, Li-doped MOF-C16 is depicted in green, Li-doped MOF-C22 is depicted in red, and Li-doped MOF-C30 is depicted in black. The total and excess isotherm data at 273 and 300 K are indicated in detail in Tables 5 through 9, below.

Table 5 lists the simulated H₂ adsorption data for Li-MOF-C6 at 273 and 300 K.

TABLE 5
Li-MOF-C6

| | 273 K | | 300 K | |
|---|---|---|---|---|
| Pressure | Total H₂ per | Excess H₂ per | Total H₂ per | Excess H₂ per |
| (bar) | f.u.^{a} | f.u.^{a} | f.u.^{a} | f.u.^{a} |
| 1 | 1.58 | 1.51 | 1.09 | 1.04 |
| 5 | 3.64 | 3.37 | 2.67 | 2.41 |
| 10 | 5.02 | 4.55 | 3.79 | 3.36 |
| 20 | 6.51 | 5.76 | 5.37 | 4.65 |
| 30 | 7.47 | 6.49 | 6.33 | 5.41 |
| 40 | 8.27 | 7.11 | 7.10 | 6.00 |
| 50 | 8.88 | 7.54 | 7.76 | 6.49 |
| 100 | 11.12 | 9.01 | 10.04 | 8.03 |

^{a}f.u. = Zn₄OLₓ formula unit

Table 6 lists the simulated H₂ adsorption data for Li-MOF-C10 at 273 and 300 K.

TABLE 6
Li-MOF-C10

| | 273 K | | 300 K | |
|---|---|---|---|---|
| Pressure | Total H₂ per | Excess H₂ per | Total H₂ per | Excess H₂ per |
| (bar) | f.u.^{a} | f.u.^{a} | f.u.^{a} | f.u.^{a} |
| 1 | 4.26 | 4.17 | 2.64 | 2.55 |
| 5 | 8.91 | 8.55 | 6.66 | 6.32 |
| 10 | 11.18 | 10.58 | 8.97 | 8.40 |
| 20 | 13.65 | 12.69 | 11.61 | 10.71 |
| 30 | 15.16 | 13.93 | 13.19 | 12.03 |
| 40 | 16.41 | 14.93 | 14.40 | 13.01 |
| 50 | 17.48 | 15.76 | 15.38 | 13.77 |
| 100 | 20.86 | 18.00 | 19.03 | 16.35 |

^{a}f.u. = Zn₄OLₓ formula unit

Table 7 lists the simulated H₂ adsorption data for Li-MOF-C16 at 273 and 300 K.

TABLE 7
Li-MOF-C16

| | 273 K | | 300 K | |
|---|---|---|---|---|
| Pressure | Total H₂ per | Excess H₂ per | Total H₂ per | Excess H₂ per |
| (bar) | f.u.^{a} | f.u.^{a} | f.u.^{a} | f.u.^{a} |
| 1 | 8.52 | 8.32 | 5.99 | 5.80 |
| 5 | 15.51 | 14.81 | 12.14 | 11.49 |
| 10 | 19.01 | 17.91 | 15.83 | 14.79 |
| 20 | 22.95 | 21.21 | 19.71 | 18.08 |
| 30 | 25.45 | 23.10 | 22.56 | 20.35 |
| 40 | 27.40 | 24.41 | 24.35 | 21.56 |
| 50 | 29.07 | 25.45 | 26.40 | 23.05 |
| 100 | 35.21 | 28.55 | 32.43 | 26.24 |

^{a}f.u. = Zn₄OLₓ formula unit

Table 8 lists the simulated H₂ adsorption data for Li-MOF-C22 at 273 and 300 K.

TABLE 8
Li-MOF-C22

| | 273 K | | 300 K | |
|---|---|---|---|---|
| Pressure | Total H₂ per | Excess H₂ per | Total H₂ per | Excess H₂ per |
| (bar) | f.u.^{a} | f.u.^{a} | f.u.^{a} | f.u.^{a} |
| 1 | 12.52 | 12.23 | 9.29 | 9.02 |
| 5 | 21.46 | 20.52 | 17.16 | 16.28 |
| 10 | 26.09 | 24.62 | 21.61 | 20.23 |
| 20 | 30.89 | 28.44 | 26.63 | 24.34 |
| 30 | 34.31 | 30.82 | 30.81 | 27.57 |
| 40 | 36.53 | 32.03 | 32.35 | 28.19 |
| 50 | 38.75 | 33.23 | 35.55 | 30.47 |
| 100 | 47.92 | 37.62 | 44.10 | 34.50 |

^{a}f.u. = Zn₄OLₓ formula unit

Table 9 lists the simulated H₂ adsorption data for Li-MOF-C30 at 273 and 300 K.

TABLE 9
Li-MOF-C30

| | 273 K | | 300 K | |
|---|---|---|---|---|
| Pressure | Total H₂ per | Excess H₂ per | Total H₂ per | Excess H₂ per |
| (bar) | f.u.^{a} | f.u.^{a} | f.u.^{a} | f.u.ₐ |
| 1 | 22.04 | 21.66 | 18.21 | 17.85 |
| 5 | 31.91 | 30.73 | 27.38 | 26.27 |
| 10 | 37.02 | 35.12 | 32.56 | 30.78 |
| 20 | 43.12 | 39.77 | 38.89 | 35.80 |
| 30 | 47.46 | 42.54 | 42.83 | 38.35 |
| 40 | 51.09 | 44.71 | 46.76 | 40.92 |
| 50 | 54.21 | 46.35 | 49.50 | 42.29 |
| 100 | 66.87 | 52.20 | 61.18 | 47.68 |

^{a}f.u. = Zn₄OLₓ formula unit

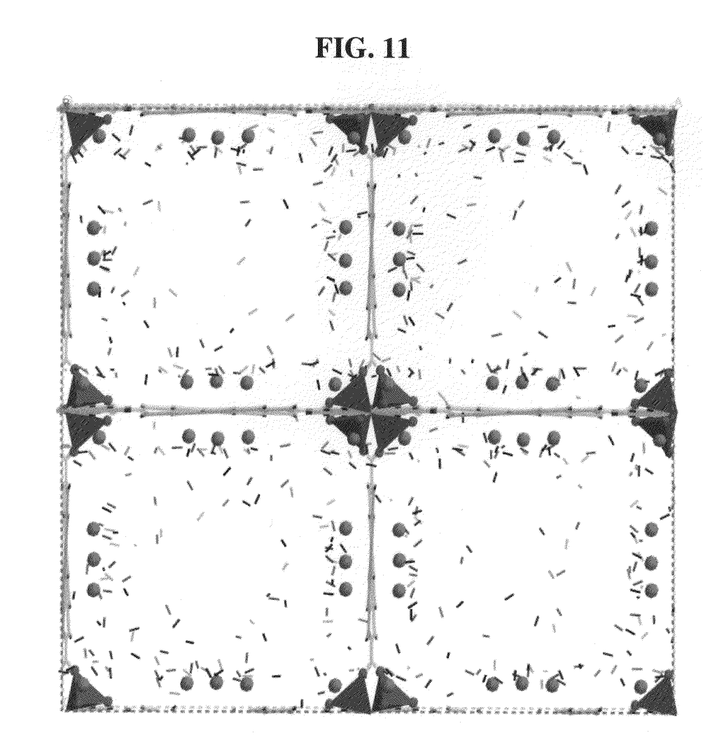

FIG. 11 is a graph of the distribution of H₂ in the Li-doped MOF-C30 at 243 K and 100 bar. In FIG. 11, hydrogen atoms are depicted in black, carbon atoms are depicted in grey, lithium atoms are depicted in pink, oxygen atoms are depicted in red, and zinc atoms are depicted in violet. As shown in FIG. 11, the H₂ uptake of Li-doped MOF-C30 reaches 6 wt %, meeting the 2010 DOE target. The adsorbed H₂ are found mainly near Li atoms on the aromatic carbon atoms.

To validate the FF and GCMS calculations used to predict the H₂ uptake of the exemplary doped MOFs, the simulations were also carried out on undoped MOF-C6 (i.e. IRMOF-1 reported by Yaghi, et al. in U.S. Patent Publication No. 2003/0004364, the entire content of which is incorporated herein by reference), MOF-C10 (i.e., IRMOF-8 reported by Yaghi, et al.), and MOF-C16 (i.e., IRMOF-14 reported by Yaghi, et al.). The gravimetric H₂ uptake of these undoped MOFs were measured, and the experimental results were compared to the results obtained by the simulations. The simulations show that the H₂ uptake of undoped MOF-C6 at 77K and 1 bar is 1.28 wt %, which compares well with the experimental result of 1.32 wt %. For MOF-C10 at 77K and 1 bar, the simulation yielded a H₂ uptake of 1.62 wt %, which compares well with the experimental value of 1.50 wt %. In addition, for MOF-C6, the simulation yielded 4.17 wt % at a pressure of 20 and 77K, which compares well with the experimental value of approximately 4.6 wt %. Also, at 300K, the simulation predicts that MOF-C6 has 0.35 wt % at 60 bar (which compares well to the experimental value of 0.45 wt %) and that MOF-C10 has 0.3 wt % at 30 bar (which compares well to the experimental value of 0.4 wt %). These results validate the FF and GCMS simulation techniques. However, as can be seen from the simulations and experimental values, at 300K, the pure, undoped MOFs have low H₂ uptake of less than 1 wt %, even at 100 bar, which is far too small for practical use.

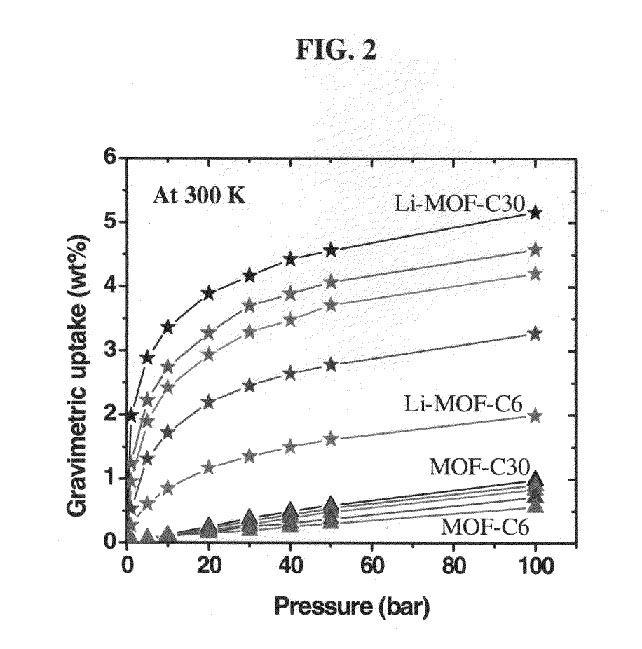

The doped MOF systems according to embodiments of the present invention show significantly improved H₂ storage at room temperature. As shown in FIG. 2, the simulated H₂ uptake of each of the lithium-doped MOF-C6, -C10, -C16, -C22 and -C30 systems are significantly greater than the predicted (and reported) H₂ uptake of each of the pure, undoped MOF-C6, -C10, -C16, -C22 and -C30 systems. Referring to FIG. 2, at 300K and 20 bar pressure, Li-doped MOF-C30 binds 3.89 wt % H₂, and at 300K and 50 bar pressure, the H₂ uptake increases to 4.56 wt %. This H₂ uptake is the highest room temperature reversible hydrogen storage capacity yet reported, and is an order of magnitude higher than that of pure, undoped MOF-C30 (which has a H₂ uptake of 0.25 wt % at 20 bar pressure, and 0.56 wt % at 50 bar pressure) and MOF-C6 (which has a H₂ uptake of 0.15 wt % at 20 bar pressure, and 0.30 wt % at 50 bar pressure). Even at 1 bar and 300K, Li-doped MOF-C30 stores 1.98 wt % H₂, significantly more than its pure, undoped counterpart, as shown in FIG. 2.

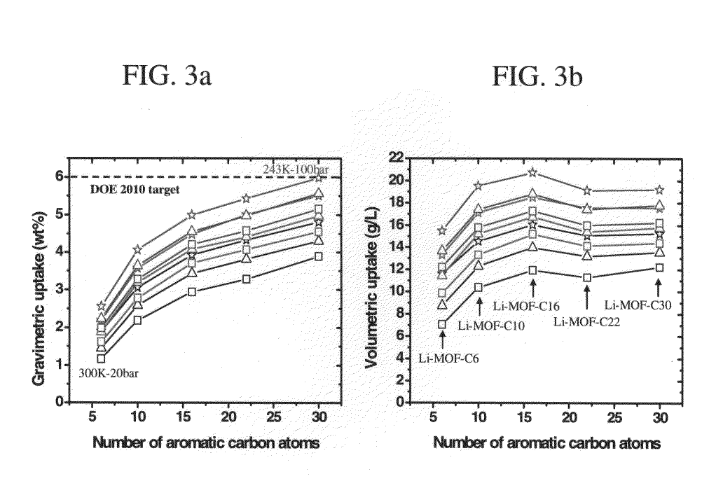

FIG. 3a shows the gravimetric H₂ uptake for Li-doped MOFs at various temperature and pressure conditions, and FIG. 3b shows the volumetric H₂ uptake for the Li-doped MOFs. For all temperatures and pressures, Li-doped MOF-C30 has the highest gravimetric H₂ uptake. For example, at a pressure of 100 bar, Li-doped MOF-C30 has an H₂ uptake of 5.16 wt % at 300K, 5.57 wt % at 273K and 5.99 wt % at 243K, meeting the 2010 DOE target of 6.0 wt %. The best volumetric H₂ uptake at a pressure greater than 50 bar is found in the doped MOF-C16 system. At 100 bar, this system stores 17.31 g/L H₂ at 300K, 18.83 g/L H₂ at 273K, and 20.76 g/L H₂ at 243K.

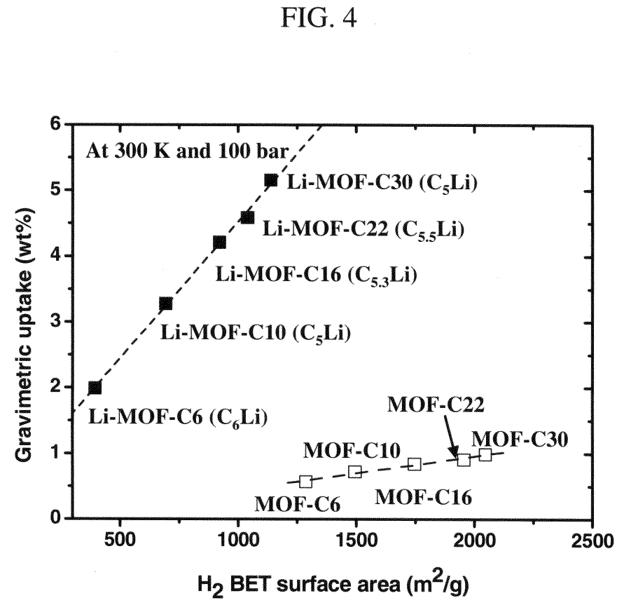

The H₂ uptake behavior as a function of the internal surface area of the MOFs is summarized in FIG. 4. FIG. 4 compares the gravimetric H₂ uptake at 300 K and 100 bar as a function of H₂BET surface area of doped MOFs according to embodiments of the present invention and undoped MOFs. As shown in FIG. 4, both surface area and the ratio of Li to C are important for high performance. FIG. 7 compares the Connelly surface area and BET surface area of some pure, undoped MOFs. As can be seen from FIG. 7, the Connelly surface area is about 3 times the BET surface area. The Connelly surface area is calculated as the surface area available to a ball of a radius of 1.2 Å rolled over the various atoms. For pure, undoped MOF systems, a weak linear correspondence exists, indicating that the additional exposed area of aromatic carbon contributes little to H₂ adsorption. For the Li-doped MOFs, such a linear relationship does not exist. Instead, the H₂ uptake depends on the dopant (e.g., Li) concentration more than on the surface area. In particular, the dopant (e.g., Li) concentration is the dominant factor for high H₂ uptake near room temperature. For example, Li-doped MOF-C22 and -C30 have similar surface areas (3040 and 3938 m2/g, respectively), but Li-doped MOF-C30 (with a Li concentration of C5Li) has 12.7% greater H₂ uptake than Li-doped MOF-C22 (with a Li concentration of C5.5Li).

The first principles based simulations show that the doped MOF systems according to embodiments of the present invention can reach the 2010 DOE H₂ storage targets (i.e., greater than or equal to 6.0 wt % gravimetric H₂ uptake at temperature ranging from −30 to 80° C. at a pressure less than or equal to 100 bar). Thus, at −30° C. and 100 bar, Li-doped MOF-C30 has 6.0 wt % H₂ uptake. Even at 300K, Li-doped MOF-C30 has 5.2 wt % at 100 bar. This suggests that Li-doped MOF systems are good materials for practical hydrogen storage.

In the pure, undoped MOFs, the H₂ molecule binds weakly with both the metal oxide clusters and the aromatic linking ligands with binding energies of 1.5 and 0.9 kcal/mol, respectively. This leads to H₂ uptake in pure, undoped MOF systems only at temperatures of 77K and lower. However, for the doped MOFs according to embodiments of the present invention, the high electron affinity of the aromatic sp2 carbon framework promotes separation of the charge, making the dopant (e.g., Li) positive (acidic). This provides strong stabilization of molecular H₂, leading to effective binding energies of 4.0 kcal/mol, and enhancing high temperature H₂ uptake.

The open structures and large surface areas of the MOFs according to embodiments of the present invention make the MOFs particularly suitable for the storage of hydrogen in fuel cells, especially for fuel cells used for transportation applications. In particular, the doped-MOFs of embodiments of the present invention exhibit significantly increased H₂ uptake capacity near ambient conditions. Indeed, at −30° C. and 100 bar, the Li-doped MOF-C30 according to an embodiment of the present invention, leads gravimetric H₂ uptake with 6.0 wt %, reaching the 2010 DOE target of at least 6.0 wt % at a temperature ranging from −30 to 80° C. and a pressure less than or equal to 100 bar.

The present invention has been described with reference to exemplary embodiments, but is not limited thereto. Persons skilled in the art will appreciate that other modifications and applications can be made without meaningfully departing from the invention. For example, the inventive MOFs have been described as useful for the uptake and storage of H₂ for use in hydrogen fuel cells useful for transportation applications. However, it is understood that other the inventive MOFs are also useful for the uptake and storage of species other than H₂, including other gases, such as methane, and that the MOFs are useful in applications other than fuel cells and for purposes other than transportation. Accordingly, the foregoing description should not be read as limited to the precise embodiments described, but should be read consistent with and as support for the following claims, which are to have their fullest and fairest scope.

What is claimed is:

1. A metal-organic framework comprising:
a plurality of metal clusters, each metal cluster comprising at least one metal ion;
at least one multi-dentate linking ligand connecting the plurality of metal clusters, the at least one multi-dentate linking ligand comprising at least one phenyl ring; and
at least one dopant.

2. The metal-organic framework of claim 1, wherein each metal cluster of the plurality of metal clusters is selected from the group consisting of metal clusters represented by MmXn, wherein M is selected from the group consisting of Li⁺, Na⁺, K⁺, Rb⁺, Be⁺, Mg²⁺, Ca²⁺, Sr²⁺, Ba²⁺, Sc³⁺, Y³⁺, Ti⁴⁺, Zr⁴⁺, Hf⁺, V⁴⁺, V³⁺, V²+, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺, and combinations thereof, X is selected from the group consisting of anions of non-metal atoms from Groups 14 through 17, wherein m is an integer ranging from 1 to 10, and x is selected to charge balance the metal cluster.

3. The metal-organic framework of claim 2, wherein X is selected from the group consisting of anions of O, N and S.

4. The metal-organic framework of claim 2, wherein the plurality of metal clusters comprises a plurality of Zn₄O clusters.

5. The metal-organic framework of claim 1, wherein the plurality of metal clusters comprises at least one non-linking ligand.

6. The metal-organic framework of claim 5, wherein the non-linking ligand is selected from the group consisting of O²⁻, sulfate, nitrate, nitrite, sulfite, bisulfite, phosphate, hydrogen phosphate, dihydrogen phosphate, diphosphate, triphosphate, phosphite, chloride, chlorate, bromide, bromate, iodide, iodate, carbonate, bicarbonate, sulfides, hydrogen sulphate, selenide, selenate, hydrogen selenate, telluride, tellurate, hydrogen tellurate, nitride, phosphide, arsenide, arsenate, hydrogen arsenate, dihydrogen arsenate, antimonide, antimonate, hydrogen antimonate, dihydrogen antimonate, fluoride, boride, borate, hydrogen borate, perchlorate, chlorite, hypochlorite, perbromate, bromite, hypobromite, periodate, iodite, hypoiodite, and mixtures thereof.

7. The metal-organic framework of claim 1, wherein the multi-dentate ligand is selected from the group consisting of substituted and unsubstituted ligands represented by Formula 1 through 22: 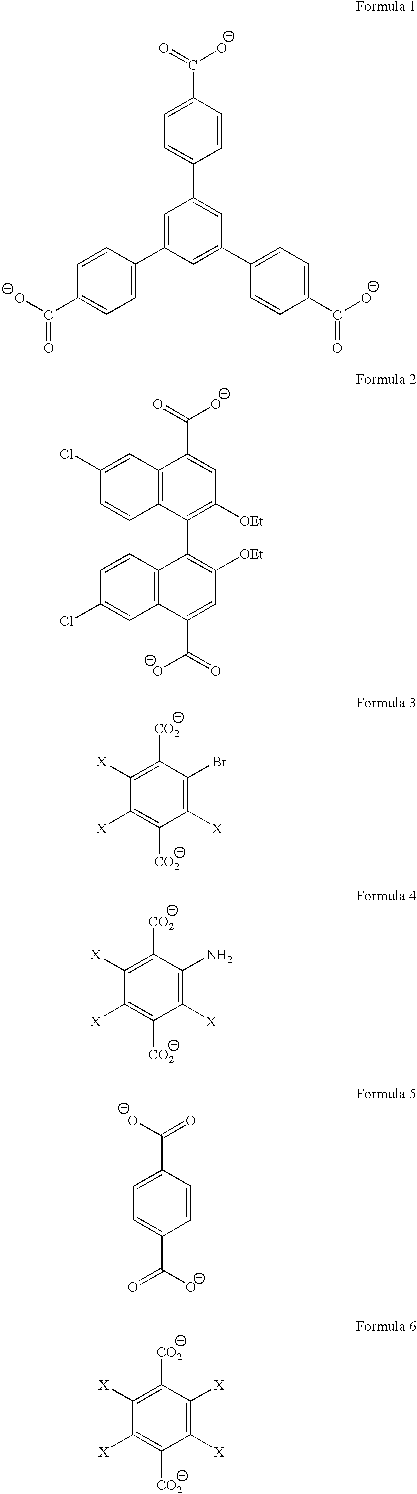 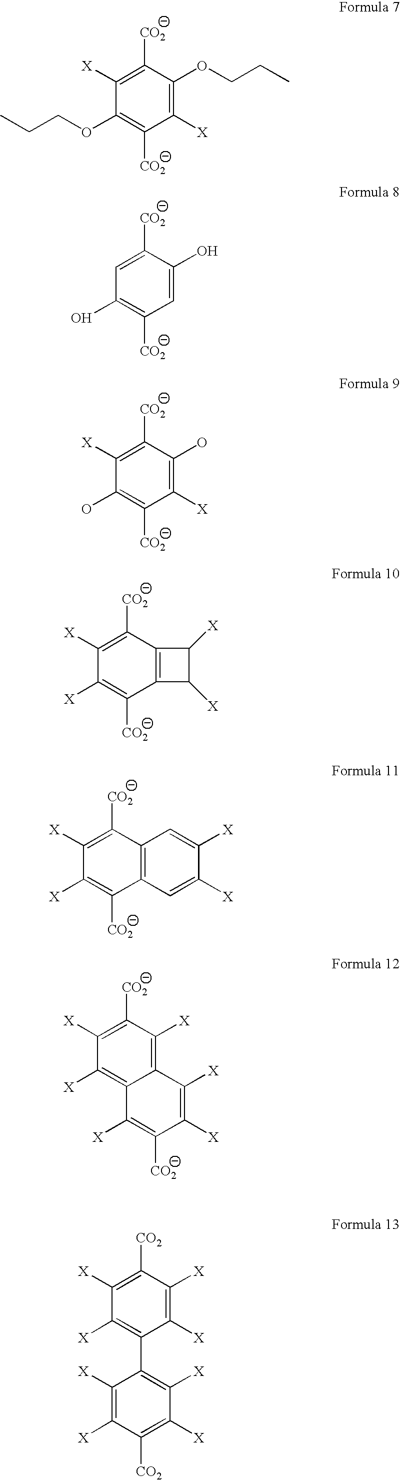 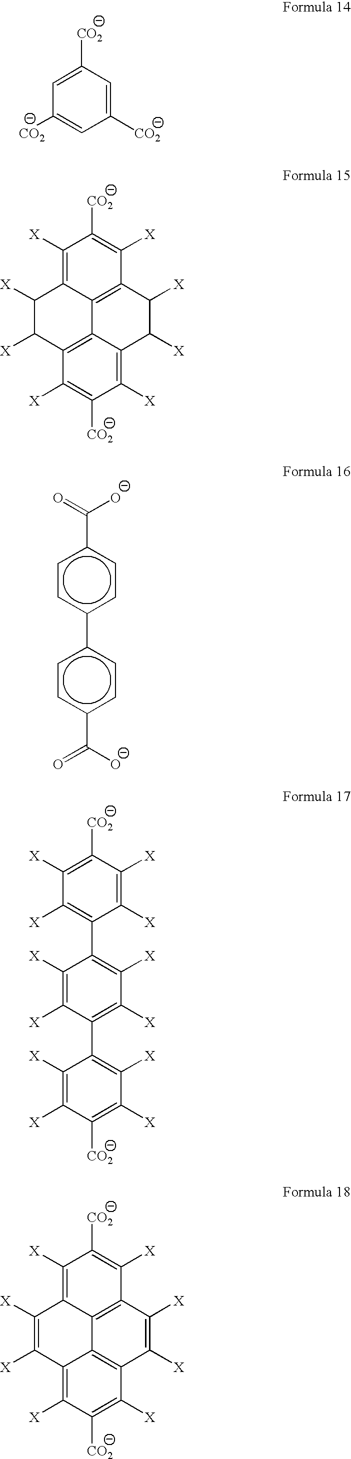 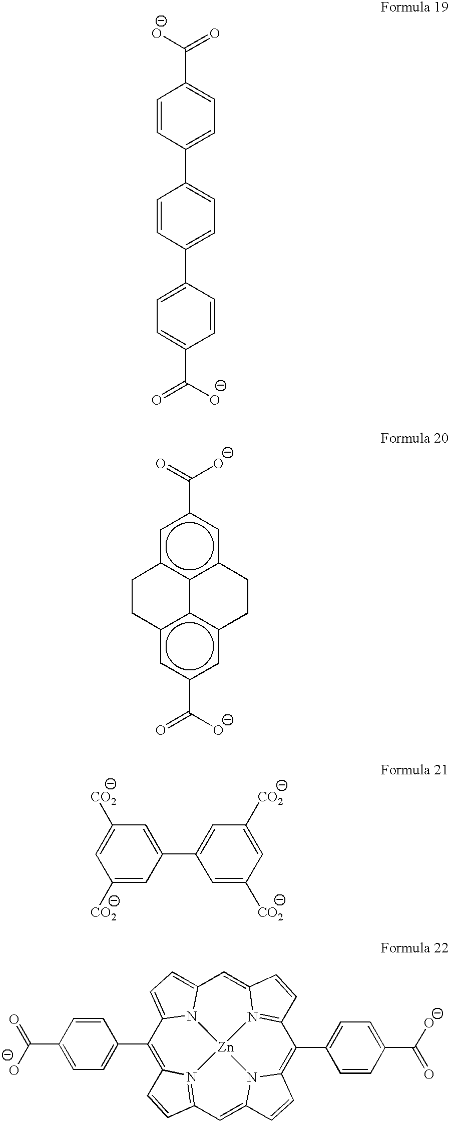
wherein M is a metal atom, R is selected from the group consisting of C1-10 alkyls, and X is selected from the group consisting of hydrogen, —NHR, —N(R)₂, halides, C1-10 alkyls, C6-18 aryls, C6-18 aralkyls, —NH₂, alkenyls, alkynyls, —Oalkyl, —NH(aryl), cycloalkyls, cycloalkenyls, cycloalkynyls, —(CO)R, —(S₂)R, —(CO₂)R, —SH, —S(alkyl), —SO₃H, —SO³⁻M⁺, —COOH, —COO⁻M⁺, —PO₃H₂, —PO₃H⁻M⁺, —PO₃²⁻M²⁺, —NO₂, —CO₂H, silyl derivatives, borane derivatives, ferrocenes and metallocenes.

8. The metal-organic framework of claim 1, wherein the multi-dentate ligand is selected from the group consisting of substituted and unsubstituted ligands represented by Formula 23 through 34: 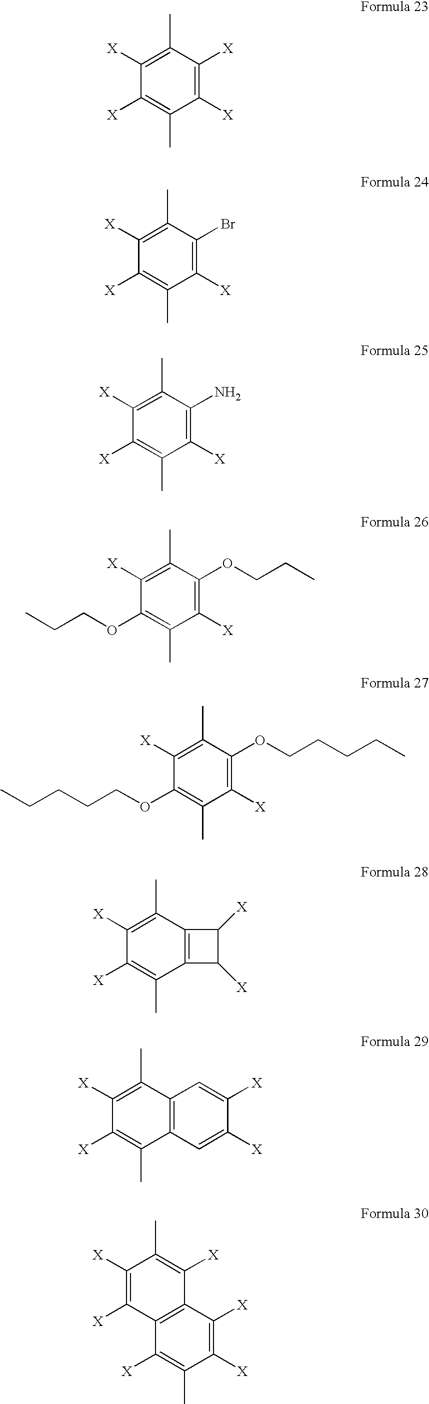 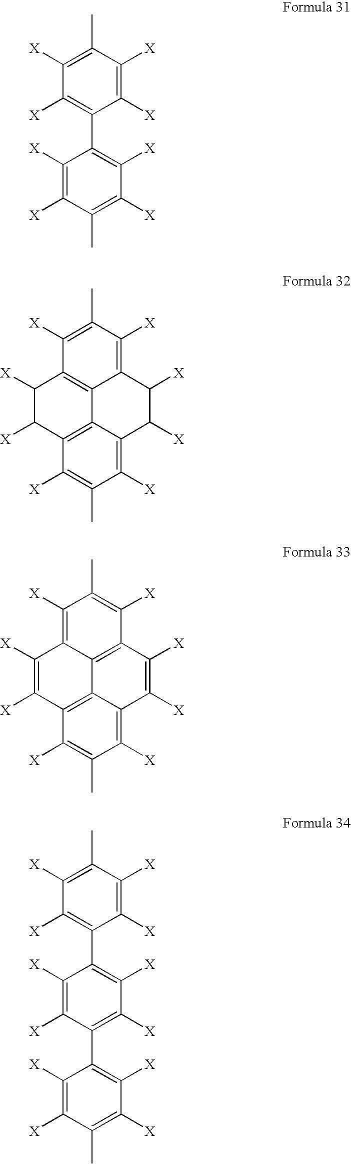
wherein X is selected from the group consisting of amines, aromatic amines, pyridine, pyrimidine like five and six membered rings, halides, halogen substituted R groups (—RX), alcohols, thiols, sulfonates, nitro groups, phosphates, epoxides, alkanes, alkenes, alkynes, aldehydes, ketones, esters, carboxylic acids, cycloalkanes, cycloalkenes, cycloalkynes, silyl derivatives, borane derivatives, ferrocenes and other metallocenes.

9. The metal-organic framework of claim 1, wherein the plurality of metal clusters comprises a plurality of Zn₄O(CO₂)₆ clusters, and the at least one multi-dentate linking ligand is selected from the group consisting of substituted and unsubstituted ligands represented by Formulae 35 through 39:

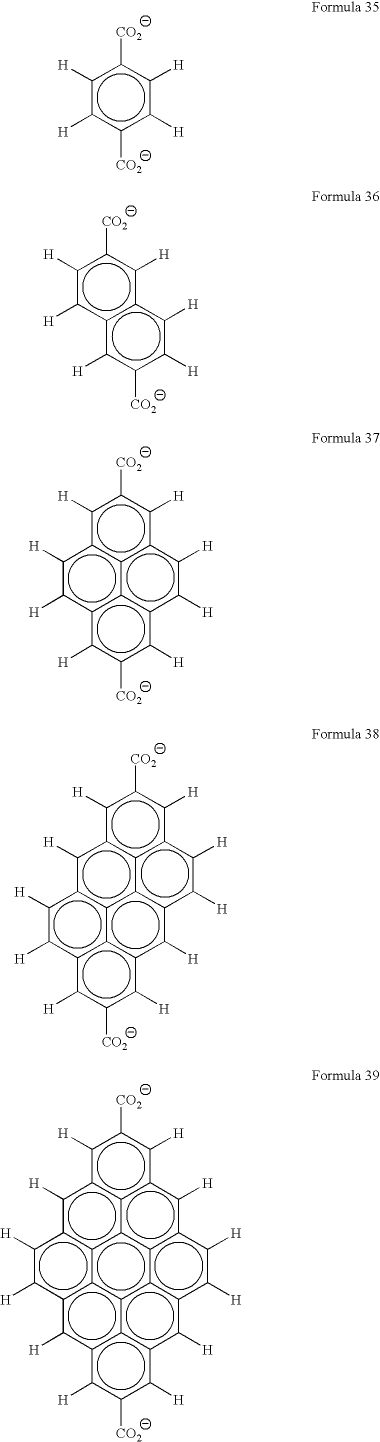

10. The metal-organic framework of claim 1, wherein the dopant is an electropositive dopant.

11. The metal-organic framework of claim 1, wherein the dopant is selected from the group consisting of elements from Groups 1 through 13, lanthanides and actinides.

12. The metal-organic framework of claim 1, wherein the dopant is an alkali dopant.

13. The metal-organic framework of claim 1, wherein the dopant is lithium.

14. The metal-organic framework of claim 1, wherein a ratio of aromatic carbon atoms to dopant atoms ranges from about 4:1 to about 7:1.

15. The metal-organic framework of claim 1, wherein a ratio of aromatic carbon atoms to dopant atoms ranges from about 5:1 to about 6:1.

16. The metal-organic framework of claim 1, wherein the dopant is present in the metal-organic framework in an amount ranging from about 2.5 to about 7.2 wt %.

17. The metal-organic framework of claim 1, wherein the dopant is present in the metal-organic framework in an amount ranging from about 2.63 to about 7.01 wt %.

18. The metal-organic framework of claim 1, wherein the plurality of metal clusters comprises a plurality of Zn₄O(CO₂)₆ clusters, and the at least one multi-dentate linking ligand is represented by Formula 39: [chemical structure]
